(19) United States
(12) Patent Application Publication
(10) Pub. No.: US 2010/0001192 A1
(43) Pub. Date: Jan. 7, 2010

(54) GAMMA CAMERA SYSTEM WITH SLANTED DETECTORS, SLANTED COLLIMATORS, AND A SUPPORT HOOD

(76) Inventors: Kai Lange, Vedbaek (DK); Jens Egede Gronbech, Kokkedal (DK)

Correspondence Address: KOHN & ASSOCIATES, PLLC, 30500 NORTHWESTERN HWY, SUITE 410, FARMINGTON HILLS, MI, 48334, US

(21) Appl. No.: 12/168,287

(22) Filed: Jul. 7, 2008

(51) Int. Cl. G21K 1/02

(52) U.S. Cl. 250/363.1

(57) ABSTRACT

According to the present invention, there is provided a gamma camera system for brain SPECT imaging including slanted detectors with slanted hole collimators and a special hood-shaped head support device. The present invention eliminates the need for radial detector motion and therefore for collision sensing devices and safety related circuitry as required in prior art gamma cameras. Furthermore, the design and shape of the present invention reduces the necessary camera setup procedure, thereby improving camera workflow and output. The present invention's hood-shaped head support encapsulates the patient's head, preventing long hair from being entangled with the detectors while providing increased patient safety and comfort. Furthermore, the hood gently restrains the patients head, leading to less patient movement and improved image quality. In addition the hood enables very close detector proximity to the patient's head leading to further improvements in image quality.

### BACKGROUND OF THE INVENTION

1. Field of the Invention

This invention generally relates to the field of computerized imaging utilizing the detection of radioactivity. Specifically, the invention relates to a gamma camera system including slanted detectors with slant hole collimators and a special hood-shaped head support device.

2. Description of Related Art

Gamma camera systems are used in modern medicine as diagnostic imaging tools to support the diagnosis of a range of diseases. While the utilization of gamma cameras for diagnosing brain related diseases remains uncommon, this trend appears to be changing for several reasons, among them:
Significant research is being conducted relating to the early diagnosis of Alzheimer's and Parkinson's diseases through the use of SPECT (Single photon emission computed tomography) imaging which utilizes gamma rays.
New radiopharmaceuticals, based on I-123 and PET tracers, are already in or are close to entering clinical trials.
CMS (The US Centers for Medicare & Medicaid Services) has recently accepted reimbursement on PET (positron emission tomography), which utilizes gamma rays for diagnosis of Alzheimer's disease.
Clinical studies have documented that brain SPECT imaging is a very accurate method to diagnose brain death.
Several US psychiatrists have claimed that they can diagnose psychological disorders based on a brain SPECT scan

SPECT examinations begin with the injection of a dilution marker comprising a compound labelled with a radiopharmaceutical into the body of the patient to be examined. A radiopharmaceutical is a substance that emits photons at one or more energy levels. By choosing a compound that will accumulate in the organ or region to be imaged (in the present scenario, the brain), the concentration of the compound and the emitted photons can be substantially limited to the targeted organ or region.

In order to measure the photon intensity at the brain, a gamma camera detector is positioned adjacent the patient's head at a prescribed time following the marker injection. During the imaging period, the detector is supported in a single position and the patient remains as still as possible. At this time, the detector detects photon emissions and creates a planar view of the brain corresponding to the detector position.

With reference to FIG. 1, a gamma camera detector (2) consisting of a scintillation crystal, photomultipliers and electronic circuitry, alternatively, the detector may be a solid state detector wherein electronic circuitry is coupled directly onto multiple crystals and is equipped with a collimator (4). The collimator typically includes a lead block (6) which is pierced with tiny parallel holes (8) which define the preferred photon paths. The preferred paths of the collimator are usually perpendicular to the length of the collimator. The collimator serves to block photon emissions toward detector along non-preferred paths.

The detector electronics serve to divide the crystal surface into a number of pixels in a two-dimensional image matrix. Each photon reaching through the collimator decays within the crystal. The detector electronics determine the two-dimensional position of the decay and increment the value of the corresponding pixel in the image. Once the imaging period expires, the image matrix comprises a projection of the distribution of the pharmaceutical in the brain.

In addition to the detector and collimator, a gamma camera comprises a mechanical structure, a gantry that is used to position the detector parallel to, and at an angle about a rotation axis, to acquire a plurality of emission images. The angle is incremented between views so that the plurality of images can be used together to reconstruct pictures of transaxial slices of the brain using back projection and iterative algorithms. These transaxial slices can be used in diagnosing various neurological disorders.

There are two key elements necessary for successful SPECT examinations; Firstly, the patient must remain absolutely still during the examination. Any patient motion during the examination will cause a blur to result in both the acquired images and the reconstructed tomography slices. Secondly, the distance between the organ or region to be imaged and the detector must be kept to an absolute minimum in order to maintain the necessary resolution in the acquired images. Ideally, the collimator holes should be of an infinitely small size or diameter to ensure that the preferred path for the photons becomes a straight line perpendicular to the length of the collimator. However, the sensitivity of such a collimator would be infinitely low, requiring an unrealistically lengthy photon acquisition period, throughout which the patient must remain still. Therefore, the collimator holes have a certain diameter which, although time efficient, causes resolution in the acquired images to deteriorate as the distance to the imaged organ increases. As a consequence, a well performing gamma camera ensures that the detector remains as close as possible to the patient during imaging while at the same time being comfortable in that it offers good patient support which aids the patient to remain still during the examination.

FIG. 2 shows a typical gamma camera design, such as a Picker Prism 3000, intended for brain SPECT imaging. The system is equipped with three detectors (2), which serve to reduce the duration of the examination. The detectors are mounted 120 degrees apart, perpendicular to the axis of rotation, to enable each detector to acquire one-third of the views needed to reconstruct pictures of transaxial slices. The detectors are connected to a gantry (12) to enable rotation during the imaging process.

When in operation, the patient is positioned supine on the table (10) prior to the operator maneuvering the table with the patient on it to position the patient's head under the three detectors (2). Next, the operator positions the three detectors to be in close proximity to the head of the patient before starting the examination. Once the examination has started, the three detectors each acquire one image, and then the three detectors are rotated slightly at increments configurable by the user to acquire the next three images. This process continues to repeat until the three detectors have completed a full diagnostic circuit and acquired the predetermined total number of images as defined by the user.

Presently available camera designs present users with several shortcomings and problems. Firstly, the need to manually position the detectors to acquire images in close proximity to the patient's head, while necessary under existing camera designs in order to achieve close proximity to different head sizes, is undesirable. The use of radial detector motion increases the risk of the detectors hitting the patient, leading to possible serious injury, as the detectors are quite heavy and are driven by high force motors. For this reason, in many presently known gamma cameras, the detectors are often equipped with collision sensing devices to halt potentially dangerous motion, which adds substantially to the cost and complexity of any gamma camera. In the case of gamma cameras for use as brain scanners, the need for such safety measures is even more acute, due to the sensitivity of the human skull. As a result, in brain scanners, the detector motion must halt immediately whenever the collision senor is triggered, requiring very precise and expensive engineering, or alternatively, the system must ensure that the detector is a sufficient distance away from the patient's head to allow room for halting the detector, thereby conflicting with the desire for close proximity imaging.

Furthermore, due to the rotation of the detectors in close proximity to the patient's head, the operator must take necessary precautions to prevent the patient's hair from becoming entangled in the moving detectors. These precautions can take the form of the use of a hairnet, which takes time to apply and remove before and after the examination. In addition, it takes time to lightly restrain the patient's head to aid the patient in minimizing motion during the examination.

### SUMMARY OF THE INVENTION

According to the present invention, there is provided a gamma camera system for brain SPECT imaging including slanted detectors with slanted hole collimators and a special hood-shaped head support device. The present invention eliminates the need for radial detector motion and therefore for collision sensing devices and safety related circuitry as required in prior art gamma cameras. Furthermore, the design and shape of the present invention reduces the necessary camera setup procedure, thereby improving camera workflow and output. The present invention's hood-shaped head support encapsulates the patient's head, preventing long hair from being entangled with the detectors while providing increased patient safety and comfort. Furthermore, the hood gently restrains the patient's head, leading to less patient movement and improved image quality. In addition the hood enables very close detector proximity to the patient's head leading to further improvements in image quality.

### DESCRIPTION OF THE DRAWINGS

Other advantages of the present invention will be readily appreciated, as the same becomes better understood by reference to the following detailed description when considered in connection with the accompanying drawings wherein:

FIG. 1 shows a conceptual diagram of a typical gamma camera setup;

FIG. 2 shows a typical prior art gamma camera system;

FIG. 3 shows the gamma camera of the present invention including the slanted detectors;

FIG. 4 shows the positioning of the patient's head relative to the detectors of the present invention;

FIG. 5 shows the structure of the prior art detector and collimator as well as the slanted detector and collimator of the present invention;

FIG. 6 shows the head support hood of the present invention;

FIG. 7 shows an example of the preferred embodiment of gamma camera system of the present invention; and

FIG. 8 depicts an example of the upright embodiment of the present invention.

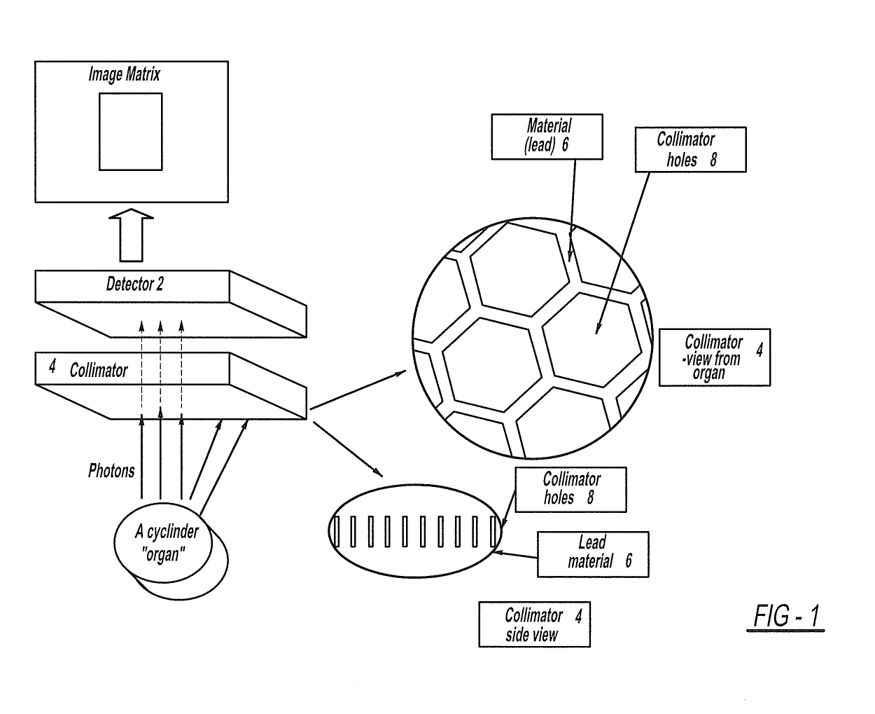

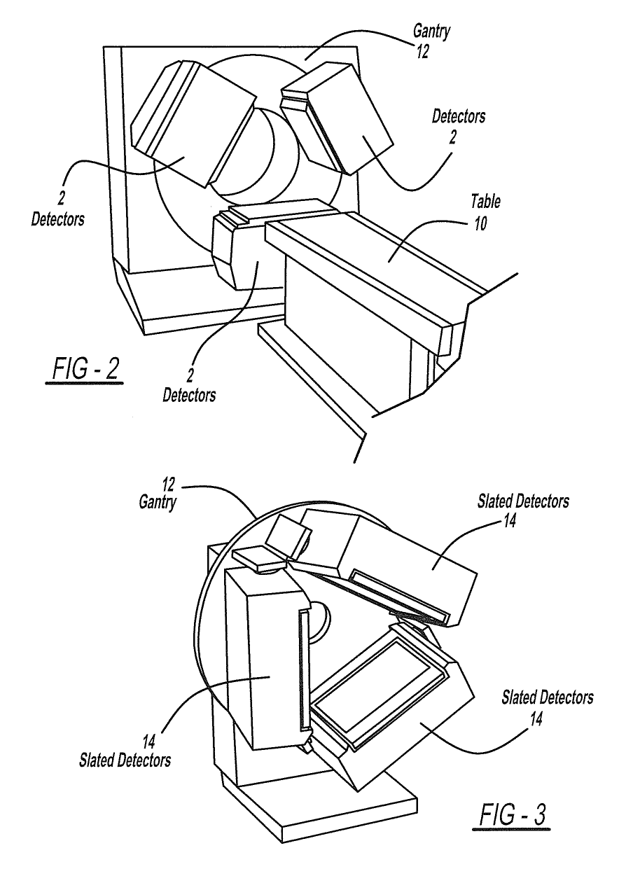

### DETAILED DESCRIPTION OF THE INVENTION

The present invention overcomes the shortcomings of the prior art by presenting a gamma camera dedicated to brain SPECT imaging which is engineered to eliminate the need for radial detector motion and also incorporating a specialized head support device.

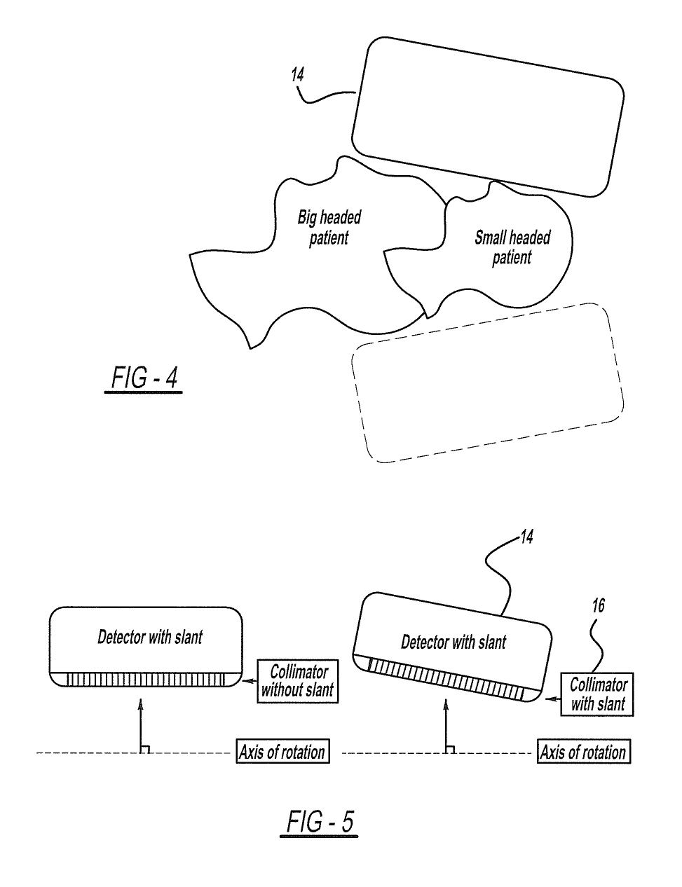

In the present invention, the detectors (14) are mounted at a slanted angle, rather than at an angle perpendicular to the axis of rotation as found in prior art systems, as depicted in FIG. 3. Additionally, the present invention eliminates the detector's radial motion found in prior art systems. The design of the present invention results in the distance from the detector to the axis of rotation decreasing across the detector surface (Y direction). The distance is greatest furthest away from the gantry and smallest at the edge of the detector closest to the gantry. By choosing the detector slant angle and the minimum or maximum distance from the detector to the axis of rotation, the camera can be designed to perform brain SPECT imaging of patients with both big and small heads. Small heads will be imaged in a position closest to the back edge of the detectors toward the gantry and larger heads closer to the front edge of the detectors as shown in FIG. 4.

To compensate for the offset in imaging angle caused by the slanted detectors, the detectors (14) in the present invention are equipped with slanted hole collimators (16). The collimator holes are slanted by 360 degrees less the detector slant angle to retain image acquisition perpendicular to the axis of rotation as shown in FIG. 5. In the preferred embodiment, the collimator holes and detectors are slanted at a 10-degree angle, although other angles can be used in alternate embodiments.

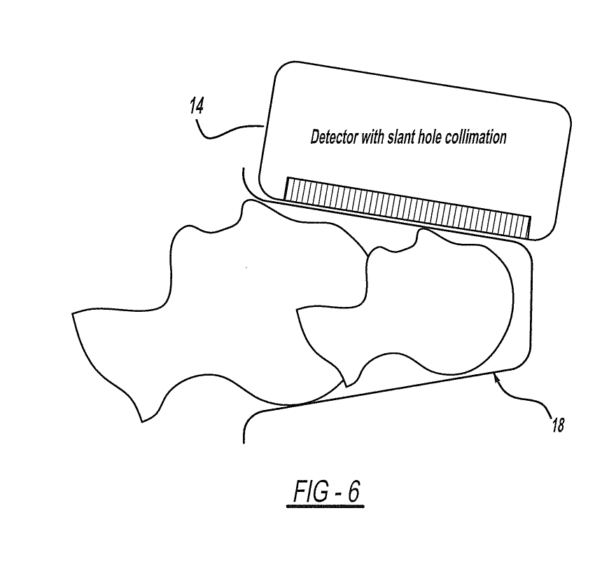

The present invention further includes a hood shaped head support (18) which serves to gently restrain and enclose the patient's head to support it in the right position for the duration of the examination. As depicted in FIG. 6, the head support hood (18) is angled such that the opening of the hood is wider, and the hood becomes gradually more tapered towards the closed end of the hood. The implementation of the head support hood serves to allow the detectors (14) to be positioned safely as close as possible to the patient's head. Additionally, the head support hood also ensures that long hair will not become entangled with the detectors.

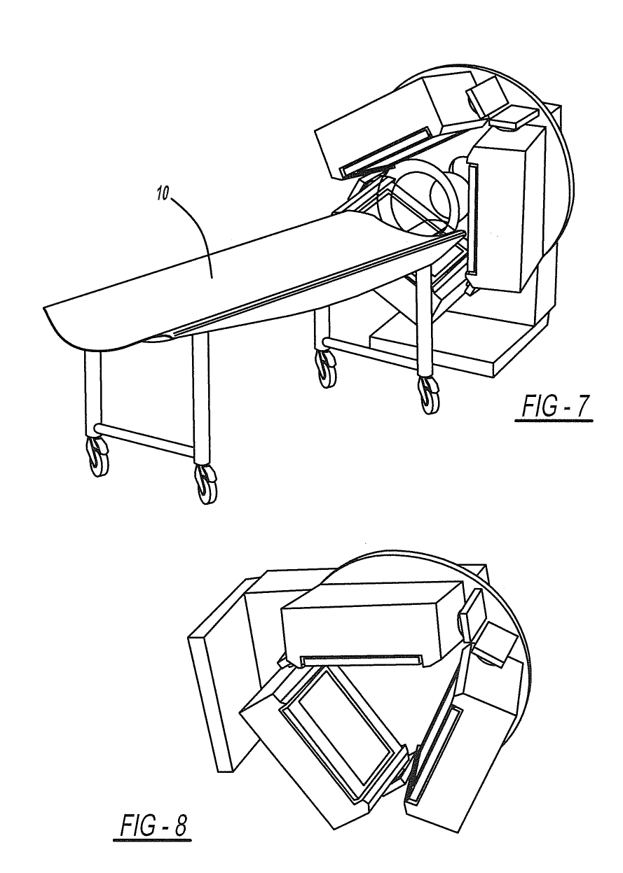

FIG. 7 depicts the preferred embodiment of the present invention, that is, a gamma camera system dedicated to brain SPECT imaging. In the preferred embodiment, the patient is positioned supine on the patient table (10). In an alternative embodiment, the gamma camera system can be implemented such that the patient is seated upright or in a semi-reclined position during the imaging process. In such an embodiment, the gantry with the rotating detectors (shown in FIG. 3) is adjusted approximately 90 degrees such that the axis of rotation becomes nearly vertical, as shown in FIG. 8. Once the patient is seated with the hood encapsulating his/her head, the gantry with detectors is moved down to perform the examination.

Implementing the present invention's upright imaging embodiment provides a number of additional advantages. FIG. 8 depicts an example of the upright embodiment of the present invention. This embodiment significantly reduces the space needed to house the gamma camera system, since patients are able to sit upright as opposed to being positioned supine as in the preferred embodiment. Furthermore, the upright embodiment eases source positioning for camera quality control and calibration Gamma cameras must be calibrated at regular intervals by positioning a radioactive point source at a predetermined distance from the detectors. Positioning the detectors upright with the detectors facing down allows the distance between the floor and the detectors to remain constant, making the calibration process much more convenient and efficient, as well as enabling the user to calibrate all of the detectors simultaneously. Additionally, in an alternative embodiment, the detectors of the present invention are attached with hinges to allow the detectors to be accurately positioned for calibration. Finally, the upright embodiment makes the design of the hood shaped head support much simpler. In a gamma camera system where the patient is positioned supine as in the preferred embodiment, the hood must be attached to the patient table and be constructed from a material that is sufficiently rigid to support the patient head without causing significant attenuation of the gamma photons. In the upright camera implementation, the patient does not need the same amount of support, and therefore the hood can be a separate device and constructed from a much lighter material, causing almost no attenuation.

The invention has been described in an illustrative manner, and it is to be understood that the terminology used is intended to be in the nature of words of description rather than of limitation.

Obviously, many modifications and variations of the present invention are possible in light of the above teachings. It is, therefore, to be understood that within the scope of the appended claims, the invention may be practiced otherwise than as specifically described.

1. A gamma camera system comprising slanted detectors, slanted collimators, and a head support device, wherein the slanted detectors are not perpendicular to the system's axis of rotation.

2. The system of claim 1, wherein said detectors are mounted to a gantry.

3. The system of claim 1, wherein said detectors are mounted on an angle such that the distance from the detector to the axis of rotation is smallest at the point where the detector is connected to the gantry, and largest at the point where the detector is farthest away from the gantry.

4. The system of claim 1, wherein said detectors are mounted with a hinge.

5. The system of claim 1, wherein said slanted collimators are slanted on an angle corresponding to the angle of the slanted detectors.

6. The system of claim 13, wherein said head support device is angled such that the open end is wider than the closed end.

7. The system of claim 13, wherein said head support device becomes progressively more tapered from the open end to the closed end.

8. The system of claim 1, wherein said head support device is constructed to reasonably accommodate all human head sizes.

9. The system of claim 1, wherein said head support device can be from a variety of materials.

10. The system of claim 1, further including a patient table with accompanying controls and adjustment functions.

11. The system of claim 1, wherein said detectors are oriented in a vertical fashion, allowing a patient to sit while being scanned.

12. A method of gamma ray imaging comprising: positioning a patient into a gamma ray imaging system with a head support device, scanning the patient using slanted detectors that are not perpendicular to the system's axis of rotation, and generating diagnostic images based on the scan.

13. The system of claim 1, wherein said head support device comprises a hood with an open end and a closed end.
